(19) United States
(12) Patent Application Publication
(10) Pub. No.: US 2008/0173113 A1
(43) Pub. Date: Jul. 24, 2008

(54) AUXILIARY TRANSMISSION FOR A MOTOR VEHICLE

(76) Inventor: JOHN VAN SCHOTHORST, Coalhurst (CA)

Correspondence Address: DENNIS T. GRIGGS, 17950 PRESTON ROAD, SUITE 1000, DALLAS, TX, 75252, US

(21) Appl. No.: 12/018,844

(22) Filed: Jan. 24, 2008

(30) Foreign Application Priority Data
Jan. 24, 2007 (CA) 2575181

(51) Int. Cl. F16H 37/00

(52) U.S. Cl. 74/11

(57) ABSTRACT

An auxiliary transmission is provided for a motor vehicle. The auxiliary trans-mission can couple and uncouple input power from the motor to a driveshaft coupled to a differential. The transmission includes a first gearset for coupling the input power to a hydraulic pump and an auxiliary power take-off unit. A second gearset is included for coupling a hydraulic motor to the driveshaft. When power is to be applied to the power take-off unit, the input power is uncoupled from the driveshaft. The hydraulic pump provides pressurized fluid to the hydraulic motor to provide power to the driveshaft. The vehicle's motor can be operated at a constant speed to provide the required power for the power take-off unit whereas the speed of the vehicle can be controlled by controlling the flow of pressurized fluid to the hydraulic motor.

### CROSS-REFERENCE TO FOREIGN PRIORITY APPLICATION

Priority is claimed under 35 U.S.C. §119 to Canadian Application No. 2,575,181 entitled “Auxiliary Transmission for a Motor Vehicle,” filed Jan. 24, 2007 by John Van Schothorst.

### BACKGROUND OF THE INVENTION

1. Field of the Invention

The present invention is related to the field of auxiliary transmissions for use in motor vehicles, more particularly, auxiliary transmissions having power take-off units for providing power to feed mixers mounted on farm vehicles and to provide motive power to drive the vehicle.

2. Description of the Related Art

Truck-mounted feed mixers have been used for many years to supply feed to livestock. Since the feed mixers derive their power source from the supporting vehicle, a problem can arise when trying to propel the vehicle at the same time as starting the mixer. This is because inadequate torque is available to the feed mixer.

Another problem that arises with feed mixers is that the ideal speed for driving the vehicle does not correlate with the ideal unloading speed of the feed mixer. If the vehicle is geared too high, which would result in excessive ground speed, the feed will not unload completely in the desired distance; rather, the vehicle will need to repeat the trip, unloading more feed each time. However, if the vehicle is geared lower to the point that it can unload properly in the desired amount of distance, the vehicle is then not capable of reaching speeds required for highway travel. This is particularly important when the location where feed is to be distributed is far away from the point where the feed is collected.

Truck-mounted feed mixers have traditionally been driven mechanically or hydrostatically. Both of these systems require rotational power, which can be obtained through a variety of methods. Mechanical systems consist of a power take-off (PTO) unit mounted directly to the transmission, or a Rear Engine Power Take-off (REPTO).

In a system with a PTO on the transmission, the feed mixer is driven through a series of driveshafts and gearboxes, powered by the PTO. In a REPTO system, the feed mixer is also driven through a series of driveshafts and gearboxes, but there is also a clutch required, as there is no way to disengage the power to the REPTO besides killing the engine.

Either the PTO or the REPTO can also be used to power a hydrostatic system as well. Instead of using a series of driveshafts and gearboxes, a hydraulic pump is connected to the power source. The pump can either be directly mounted to the power source or it can be powered by a driveshaft. Fluid-powered motors are attached to the mixer, and hoses connect the motor and the pump.

The hydrostatic mixing system can also be powered directly off of the front of the engine. Rotational power is acquired directly from the crankshaft. The hydraulic pump is mounted on the front of the truck, and connected to the crankshaft by a driveshaft.

With either hydrostatic or mechanical systems, ground speed is directly related to the rate of feed discharge. Slowing the vehicle down results in slowing down the feed mixer, which results in inconsistent discharge rates.

It is, therefore, desirable to provide an auxiliary transmission that would allow independent control of the power used to move the vehicle and the power used to operate the power take-off unit and, hence, the feed mixer.

### BRIEF SUMMARY OF THE INVENTION

An auxiliary transmission is provided for a motor vehicle having a frame, a motor, a main transmission, a driveshaft connecting the main transmission to a differential on an axle that provides power to wheels mounted on the vehicle. The auxiliary transmission can be mounted in the frame of the vehicle, inserted between the main transmission and the differential. In one embodiment, the auxiliary transmission can be connected to the main transmission with a first driveshaft, and can be further connected to the differential of the truck by a second driveshaft. It should be obvious to a person skilled in the art that power can be transferred to the auxiliary transmission from the motor via the main transmission or the motor can be directly coupled to the auxiliary transmission via the first driveshaft, omitting the main transmission altogether.

In another embodiment, the auxiliary transmission includes an internal coupling mechanism that can be engaged to transfer power from the first driveshaft directly to the second driveshaft so as to provide power from the main transmission to the differential. In yet another embodiment, the coupling mechanism can be disengaged to disconnect the transfer of power from the first driveshaft to the second driveshaft. In a further embodiment, the auxiliary transmission can connect power from the first driveshaft to an auxiliary power take-off unit to power other equipment, such as a feed mixer. In another embodiment, the auxiliary transmission can connect power from the first driveshaft to a hydraulic pump that can deliver pressurized hydraulic fluid to a hydraulic motor that can be coupled to the second driveshaft and provide power to the differential to move the vehicle.

In operation, when the auxiliary transmission is disengaged, rotational power can be transferred directly through the auxiliary transmission by engaging the coupling mechanism between the first and second driveshafts. In one embodiment, the auxiliary power take-off unit can be disengaged at this time.

When the auxiliary transmission is engaged, the coupling mechanism can be disengaged thereby causing the first and second driveshafts to disengage from one another. The hydraulic pump can then be engaged to the first driveshaft through a series of gears. In one embodiment, the hydraulic pump can provide fluid power to the hydraulic motor, transferred through hoses. In another embodiment, the hydraulic motor provides rotational power to the second driveshaft through a set of gears thereby providing power to the differential. In yet another embodiment, the ground speed of the truck can be controlled from in the cab with a hydraulic control mechanism that controls the flow of pressurized fluid from the hydraulic pump to the hydraulic motor, as well known to those skilled in the art. In still another embodiment, the hydraulic control system can include a joystick valve mechanism to control the fluid flow from the hydraulic pump to the hydraulic motor. In this embodiment, the further the joystick is moved forward, as an example, the faster the truck moves forward because more pressurized fluid is being delivered to the hydraulic motor.

In another embodiment, engaging the auxiliary transmission provides power to the auxiliary power take-off unit through a set of gears between it and the first driveshaft whereby power can be provided to a feed mixer coupled to the auxiliary power take-off unit.

In one embodiment, any gear in the main transmission can be used to provide power to the auxiliary transmission. By doing so, higher torque can be utilized in demanding situations; for example, when the vehicle is fully loaded. In another embodiment, the motor can be operated at a constant speed or RPM, either by using a hand throttle or by using the vehicle's cruise control. In this embodiment, a constant speed to the auxiliary power take-off unit can be provided so that a consistent flow-rate of feed from the feed mixer during unloading can be achieved. In another embodiment, the vehicle can operate at any ground speed in either the forward or reverse gears up to the maximum speed of the hydraulic motor.

In another embodiment, the ground speed of the vehicle can be changed at any time while delivering constant power to the feed mixer. In yet another embodiment, the auxiliary transmission can allow independent control of the power supplied to the feed mixer via the auxiliary power take-off unit and of the power applied to the differential via the hydraulic motor and second driveshaft.

Broadly stated, one embodiment of an auxiliary transmission is provided for use in a vehicle having a motor operatively coupled to a driveshaft for providing power to at least one wheel disposed on the vehicle. The auxiliary transmission includes input driveline means for receiving power from the motor; output driveline means for transferring power to the driveshaft; coupling means for operatively coupling and uncoupling the input driveline means to and from the second driveline means; a hydraulic pump; first transmission means for operatively coupling the input driveline means to the hydraulic pump; a hydraulic motor; and second transmission means for operatively coupling the hydraulic motor to the second driveline means.

Broadly stated, one embodiment of a method for transferring power to a driveshaft disposed on a motor vehicle to move the vehicle and to a power take-off unit disposed on the vehicle is provided, the method comprising the steps of: transferring power from the motor of the vehicle to input driveline means for receiving power from the motor; transferring power from the input driveline means to a hydraulic pump capable of providing pressurized hydraulic fluid; transferring power from the input driveline means to the power take-off unit; delivering pressurized hydraulic fluid from the hydraulic pump to a hydraulic motor capable of generating rotational power; and transferring rotational power from the hydraulic motor to the driveshaft thereby causing the vehicle to move.

### BRIEF DESCRIPTION OF SEVERAL VIEWS OF THE DRAWINGS

FIG. 1 is a perspective view depicting an auxiliary transmission for use with a motor vehicle.

FIG. 2 is a side elevational view depicting the auxiliary transmission of FIG. 1 mounted in a motor vehicle having a feed mixer.

### DETAILED DESCRIPTION OF THE INVENTION

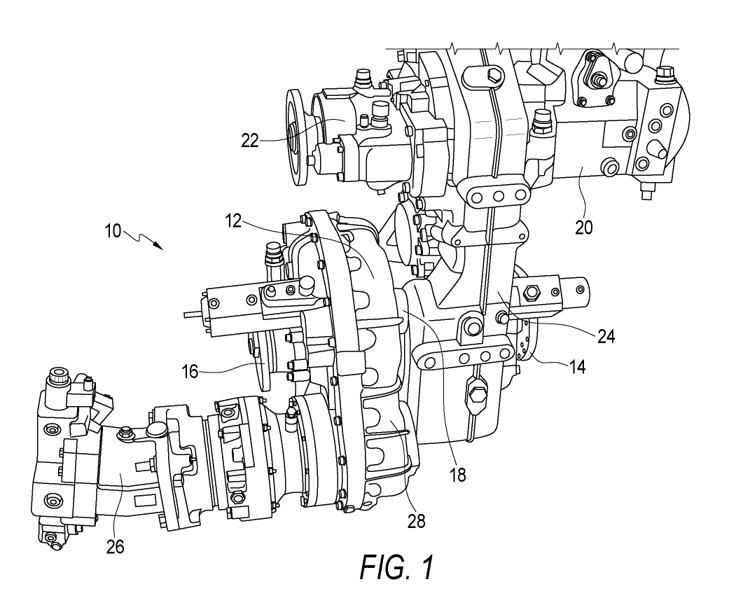

Referring to FIG. 1, auxiliary transmission 10 is shown. Auxiliary transmission 10 can comprise housing 12 that can contain input driveline means 14, output driveline means 16 and coupling means 18 disposed between the input and output driveline means. In one embodiment, coupling means 18 can couple or engage the input and output driveline means together and it can uncouple or disengage them as well. In one embodiment, coupling means 18 can include gears, belt and pulleys, chain and sprockets, splined shafts, a hydrostatic coupler such as a torque converter or any other suitable means as known to those skilled in the art for operatively coupling rotating shafts together. Coupling means 18 can be operated using mechanical linkage, hydraulic or pneumatic control mechanisms, electrical solenoid or any other suitable means known to those skilled in the art.

In one embodiment, the driveline means can comprise a flange for coupling to a driveshaft, and a shaft for transferring rotational power to or from a driveshaft, as well known to those skilled in the art. In another embodiment, auxiliary transmission 10 can comprise first transmission means 24 and second transmission means 28 within housing 12. It should be obvious to a person skilled in the art that housing 12 can be integral or it can be comprised of a number of pieces that assemble together into an integral housing.

In one embodiment, first transmission means 24 can operatively couple input driveline means 14 to hydraulic pump 20. In another embodiment, first transmission means 24 can operatively couple input driveline means 14 to auxiliary power take-off unit 22. In yet another embodiment, second transmission means 28 can operatively couple hydraulic motor 26 to output driveline means 16. In one embodiment, either or both of first and second transmission means 24 and 28 can each comprise gears, belt and pulleys, chain and sprockets, splined shafts, a hydrostatic coupler such as a torque converter or any other suitable means as known to those skilled in the art for operatively coupling rotating shafts together.

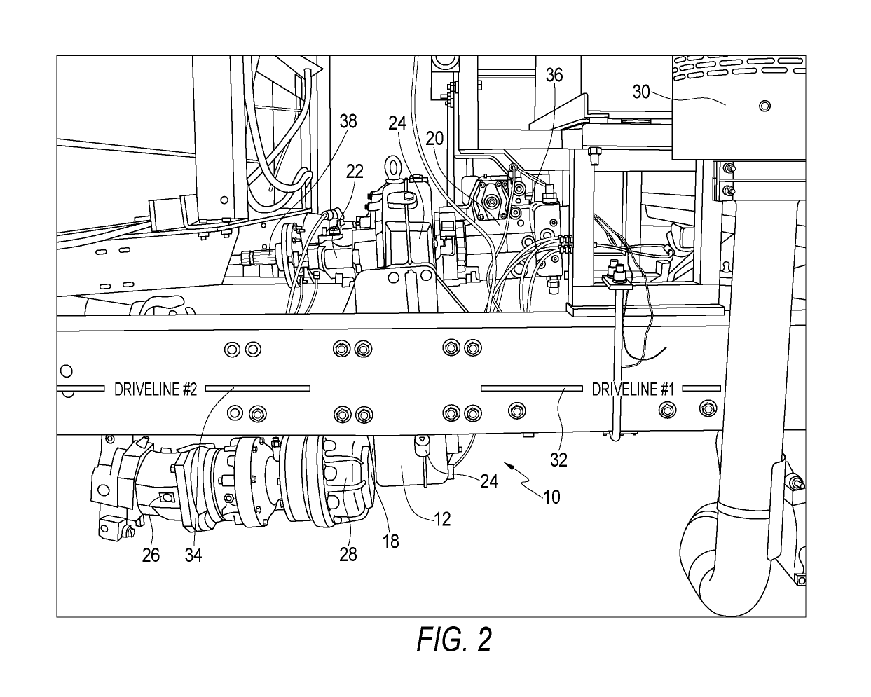

Referring to FIG. 2, auxiliary transmission 10 is shown mounted in the frame of vehicle 30. As illustrated, auxiliary power take-off unit 22 is coupled to feed mixer driveshaft 38 that provides power to a feed mixer. Driveline 32 couples power from the vehicle's motor and main transmission (not shown) to input driveline means 14 (not visible in FIG. 2). Driveline 34 couples power from output driveline means 16 (not visible in FIG. 2) to the vehicle's differential (not shown). Hydraulic pump 20 provides pressurized fluid to hydraulic motor 26 via hoses 36 and joystick control valve located in the vehicle's cab (not shown).

Although a few embodiments have been shown and described, those skilled in the art will appreciate that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

I claim:

1. An auxiliary transmission for use in a vehicle having a motor operatively coupled to a driveshaft for providing power to at least one wheel disposed on the vehicle, the auxiliary transmission comprising:
a. input driveline means for receiving power from the motor;
b. output driveline means for transferring power to the driveshaft;
c. coupling means for operatively coupling and uncoupling the input driveline means to and from the second driveline means;
d. a hydraulic pump;
e. first transmission means for operatively coupling the input driveline means to the hydraulic pump;
f. a hydraulic motor; and
g. second transmission means for operatively coupling the hydraulic motor to the second driveline means.

2. The auxiliary transmission as set forth in claim 1 further comprising an auxiliary power take-off unit operatively coupled to the first transmission means.

3. A method for transferring power to a driveshaft disposed on a motor vehicle to move the vehicle, and to a power take-off unit disposed on the vehicle, the method comprising the steps of:
a. transferring power from the motor of the vehicle to input driveline means for receiving power from the motor;
b. transferring power from the input driveline means to a hydraulic pump capable of providing pressurized hydraulic fluid;
c. transferring power from the input driveline means to the power take-off unit;
d. delivering pressurized hydraulic fluid from the hydraulic pump to a hydraulic motor capable of generating rotational power; and
e. transferring rotational power from the hydraulic motor to the driveshaft thereby causing the vehicle to move.

4. The method as set forth in claim 3 further comprising the step of increasing or decreasing the amount of pressurized hydraulic fluid delivered to the hydraulic motor to thereby control the speed of the vehicle's movement.
